(19) United States
(12) Patent Application Publication
(10) Pub. No.: US 2016/0125433 A1
(43) Pub. Date: May 5, 2016

(54) METHOD AND SYSTEM FOR DATA FORECASTING USING TIME SERIES VARIABLES

(71) Applicant: MasterCard International Incorporated, Purchase, NY (US)

(72) Inventors: Curtis VILLARS, Chatham, NJ (US); Serge Bernard, Danbury, CT (US)

(73) Assignee: MasterCard International Incorporated, Purchase, NY (US)

(21) Appl. No.: 14/528,285

(22) Filed: Oct. 30, 2014

(51) Int. Cl. G06Q 30/02; G06F 17/30

(52) U.S. Cl. CPC G06Q 30/0202; G06F 17/30342

(57) ABSTRACT

A method for identifying relationships between time series variables includes: storing a plurality of transaction data entries, each including a transaction time and transaction data; receiving a data request including a time period, time interval, a requestor time series variable, and a data value for each interval during the period; calculating for each of a plurality of processor time series variables, a data value for each interval during the period, the data values based on the transaction data and transaction times included in the transaction data entries; identifying a related processor time series variable based on a correspondence between the data value for each interval during the period for the variable and the data value for each interval during the period for the requestor time series variable; and transmitting the identified at least one related processor time series variable and the respective data values for each interval during the period.

### FIELD

The present disclosure relates to the identification of relationships between time series variables, specifically relating provided time series variables to transaction data over the same time intervals for use by a requestor.

### BACKGROUND

Consumer spending is a massive industry. The data associated thereof can thus be extremely valuable in terms of identifying relationships between consumer spending and other factors, and for use in forecasting future performance in all sorts of industries and endeavors. However, an entity that may be interested in identifying such relationships, such as a merchant, a content provider, a research facility, etc., may be unable to capture enough spending data to both properly identify a relationship and receive valuable insight. For example, a merchant may be able to capture spending data for its own payment transactions, but this data may be both inaccurate as to consumer spending patterns and insufficient in identifying valuable relationships. For instance, the merchant may be able to identify a relationship between their number of customers and overall spending at the merchant, but may have no insight as to why their number of customers, or the amount their customers are spending, is changing.

In addition, not only do such entities have a lack of sufficient consumer spending data, but often times such data is unavailable to entities even upon request. Consumer spending data can often include sensitive information that may be protected from other entities out of security or privacy concerns. Thus, entities that may desire such information may find it unavailable. Furthermore, because these entities do not possess this type of data, they may be ill-equipped to use and identify useful relationships from this data even upon receiving the information. That is, the computer systems that handle the transactions tend to be devoted to the particular merchant in that they process only transactions for that merchant. But these systems may be too expensive to build and maintain justify their use for a single merchant or even a group of merchants. Further, these systems may not be designed to capture or obtain information about the merchant's customers beyond the spending pattern, and if they are designed to obtain additional data from a third party, it requires redundant systems, additional application program interfaces, custom protocols, etc. for each merchant. For systems that facilitate transactions among multiple merchants may have the same limitations. Thus, there is a technical problem in that entities that may want to find relationship data between consumer spending and other variables may lack sufficient spending data and may be unable to obtain such data in a computationally efficient manner, and may also be unable to identify relationships between the consumer spending and other variables because of the limitations of the technology employed.

Thus, there is a need for a technical solution to identifying relationships between consumer spending over time and other time series variables in a computationally efficient manner.

### SUMMARY

The present disclosure provides a description of systems and methods employing technology for identifying relationships between time series variables for data forecasting based on transaction data representing transactions between consumers and merchants.

A method for identifying relationships between time series variables includes: storing, in a transaction database, a plurality of transaction data entries, wherein each transaction data entry includes data related to a payment transaction including at least a transaction time and/or date and transaction data; receiving, by a receiving device, a data request, wherein the data request includes a time period, a time interval, at least one requestor time series variable and, for each of the at least one requestor time series variable, a data value for each time interval during the time period; calculating, by a processing device, for each of a plurality of processor time series variables, a data value for each time interval during the time period, wherein the data values are based on the transaction data and transaction times and/or dates included in the plurality of transaction data entries stored in the transaction database; identifying, by the processing device, at least one related processor time series variable for each of the at least one requestor time series variable based on a correspondence between the data value for each time interval during the time period for the at least one related processor time series variable and the data value for each time interval during the time period for the respective requestor time series variable; and transmitting, by a transmitting device, for each of the at least one requestor time series variable, the identified at least one related processor time series variable and, for each of the identified at least one related processor time series variable, the data value for each time interval during the time period.

A system for identifying relationships between time series variables includes a transaction database, a receiving device, a processing device, and a transmitting device. The transaction database is configured to store a plurality of transaction data entries, wherein each transaction data entry includes data related to a payment transaction including at least a transaction time and/or date and transaction data. The receiving device is configured to receive a data request, wherein the data request includes a time period, a time interval, at least one requestor time series variable and, for each of the at least one requestor time series variable, a data value for each time interval during the time period. The processing device is configured to: calculate, for each of a plurality of processor time series variables, a data value for each time interval during the time period, wherein the data values are based on the transaction data and transaction times and/or dates included in the plurality of transaction data entries stored in the transaction database; and identify at least one related processor time series variable for each of the at least one requestor time series variable based on a correspondence between the data value for each time interval during the time period for the at least one related processor time series variable and the data value for each time interval during the time period for the respective requestor time series variable. The transmitting device is configured to transmit, for each of the at least one requestor time series variable, the identified at least one related processor time series variable and, for each of the identified at least one related processor time series variable, the data value for each time interval during the time period.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for identifying relationships between time series variables in accordance with exemplary embodiments.

FIG. 2 is a block diagram illustrating the processing server of FIG. 1 for identifying relationships between time series variables accordance with exemplary embodiments.

FIG. 3 is a flow diagram illustrating a process for identifying relationships between time series variables using the system of FIG. 1 in accordance with exemplary embodiments.

FIG. 4 is a diagram illustrating time series variables for consumer spending and other activities for use in identifying relationships in accordance with exemplary embodiments.

FIG. 5 is a diagram illustrating the identification of a time series variable relationship and use thereof in data forecasting in accordance with exemplary embodiments.

FIG. 6 is a flow chart illustrating an exemplary method for identifying relationships between time series variables in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

### System for Identifying Time Series Variables

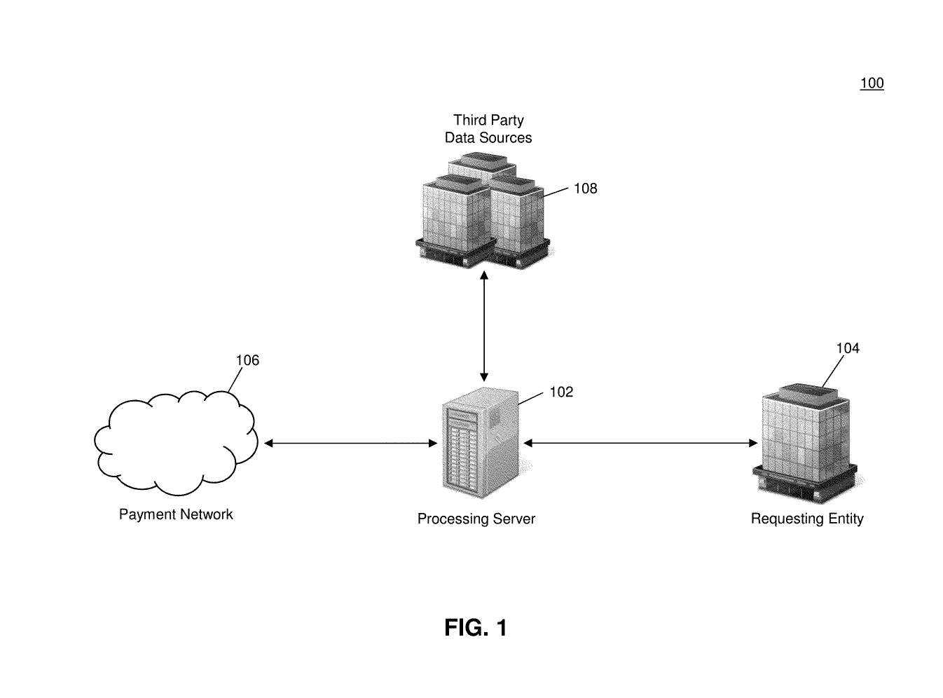

FIG. 1 illustrates a system 100 for the identification of relationships between time series variables including consumer spending variables over time.

The system 100 may include a processing server 102. The processing server 102, discussed in more detail below, may be configured to identify relationships between time series variables. A first set of time series variables may be received from a requesting entity 104. The requesting entity 104 may provide one or more time series variables to the processing server 102 for which a relationship with consumer spending is to be found. For example, if the requesting entity 104 is a restaurant, the provided time series variables may include number of consumers, total income, average ticket size, number of transactions, etc. If the requesting entity 104 is a research firm, the time series variables may include weather, social media data, transportation data, economic data, etc. For instance, a governmental agency may provide unemployment data as a time series variable for the identification of a relationship with consumer spending. Other time series variables for which relationships may be identified with consumer spending will be apparent to persons having skill in the relevant art.

Each of the time series variables provided by the requesting entity 104 to the processing server 102 may include at least a time period, a time interval, and a data value for each time interval during the time period. For instance, the time period may be six months with a one month time interval. In such an instance, the requesting entity 104 may provide a data value for the variable for each month for six consecutive months, for use by the processing server 102 in relating to consumer spending.

The processing server 102 may be configured to receive consumer spending data from one or more payment networks 106. In some embodiments, the processing server 102 may be a part of a payment network 106 and may receive consumer spending data as part of the processing of payment transactions by the payment network 106. In a further embodiment, the processing server 102 itself may be configured to process payment transactions and may capture the consumer spending data as part of the transaction processing.

Consumer spending data obtained by the processing server 102 may include transaction data for a plurality of payment transactions. The transaction data for each transaction may include at least a transaction time and/or date, and may also include additional data suitable for use in the functions discussed herein, such as a transaction amount, geographic location, merchant data, product data, etc. The processing server 102 may be configured to calculate a plurality of time series variables for the consumer spending. The time series variables may be calculated using appropriate transaction data for each of the transactions for the time period and intervals corresponding to the time series variables received from the requesting entity 104. For instance, the processing server 102 may calculate consumer spending time series variables for each month over a six month period, based on the transaction time and/or date for each transaction.

Consumer spending time series variables may include any time series variable that can be identified from transaction data, such as total number of transactions, average number of transactions per account, average ticket six, transaction frequency, number of merchants, average spending amount, or other suitable variable as will be apparent to persons having skill in the relevant art. Time series variables may also include change from one time interval to the next for any variable, such as the change in average spending amount for accounts from one time interval to the next time interval (e.g., a 2% increase, a $46 decrease, etc.).

The processing server 102 may then identify a relationship between the consumer spending time series variables and the time series variable or variables provided by the requesting entity 104. In some instances, a relationship may be directly proportional between the two variables, such as each variable increasing by the same or proportionally same amount at each time interval. In other instances, a relationship may be for two time series variables that are inversely proportional, such as where consumer spending decreases at the same or proportionally same value as an increase in a time series variable provided by the requesting entity 104.

In some embodiments, the processing server 102 may identify a relationship that includes a lead time or lag time. For example, as discussed in more detail below, a relationship may be identified between a time series variable provided by the requesting entity 104, such as unemployment rate, and a consumer spending time series variable, such as average spending amount, with the average spending amount time series variable lagging by a two time interval period (e.g., two months). For instance, the processing server 102 may determine that the average spending amount for an account changes based on change in the unemployment rate from two months prior.

In some embodiments, the processing server 102 may also be configured to identify relationships between received time series variables and additional time series variables. In such an embodiment, the processing server 102 may receive data from one or more third party data sources 108 for use in identifying additional time series variables. For example, the third party data sources 108 may include the National Weather Service, and the processing server 102 may receive weather data for use in identifying one or more weather time series variables. The processing server 102 may then use the weather time series variables for identification of a relationship with a provided time series variable. For instance, the processing server 102 may identify a relationship between the number of consumers at a merchant and the weather.

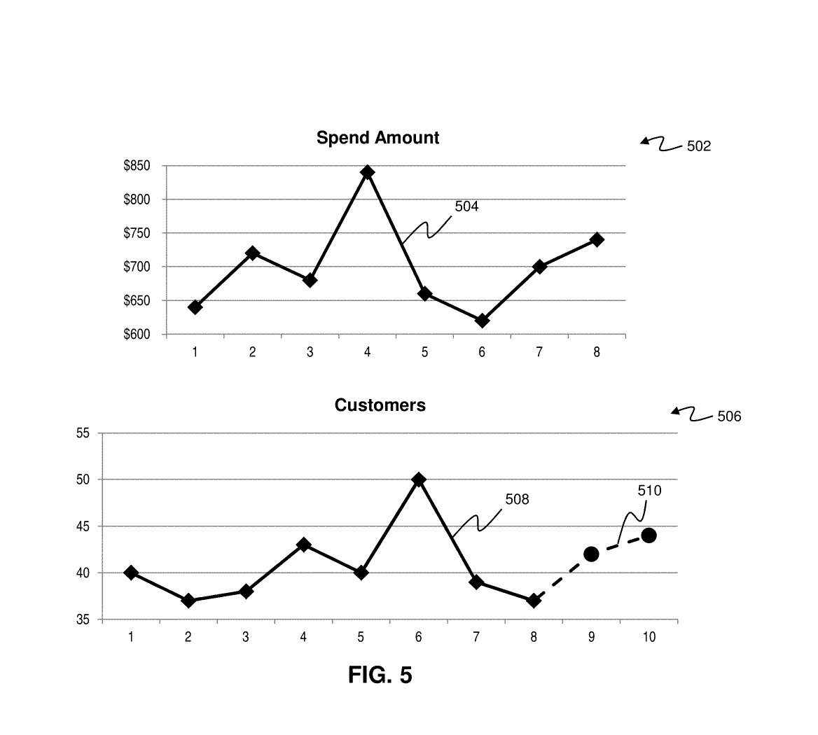

The processing server 102 may be configured to provide the identified relationship and any data associated thereof to the requesting entity 104 as a response to the received time series variable data. In some embodiments, the processing server 102 may provide analysis based on the identified relationship, such as data forecasting. For instance, the processing server 102 may forecast future performance of the time series variable based on the related consumer spending time series variable and the stored transaction data. For example, if the number of customers at a merchant lags an average spending amount by two months, the known average spending amount for a given month may be used to forecast the number of customers at the merchant two months later, as discussed in more detail below with respect to FIG. 5.

The methods and systems discussed herein may enable the processing server 102 to identify valuable relationships between provided time series variables and time series variables that are calculated using transaction data from consumer spending. The resulting relationships may be very beneficial to requesting entities 104 and may be used for a variety of purposes, such as forecasting future performance, advertising, providing content, making business decisions, etc. In addition, the position of the processing server 102 in the system 100 may enable the processing server 102 to identify relationships in instances where requesting entities 104 may be unable to obtain the necessary consumer spending data, such as in instances where the data is protected and the processing server 102 obtains the data as a result of being part of the payment network 106. In such an instance, the processing server 102 may be uniquely able to identify the relationships where the requesting entities 104 that provide the time series variables are unable.

### Processing Server

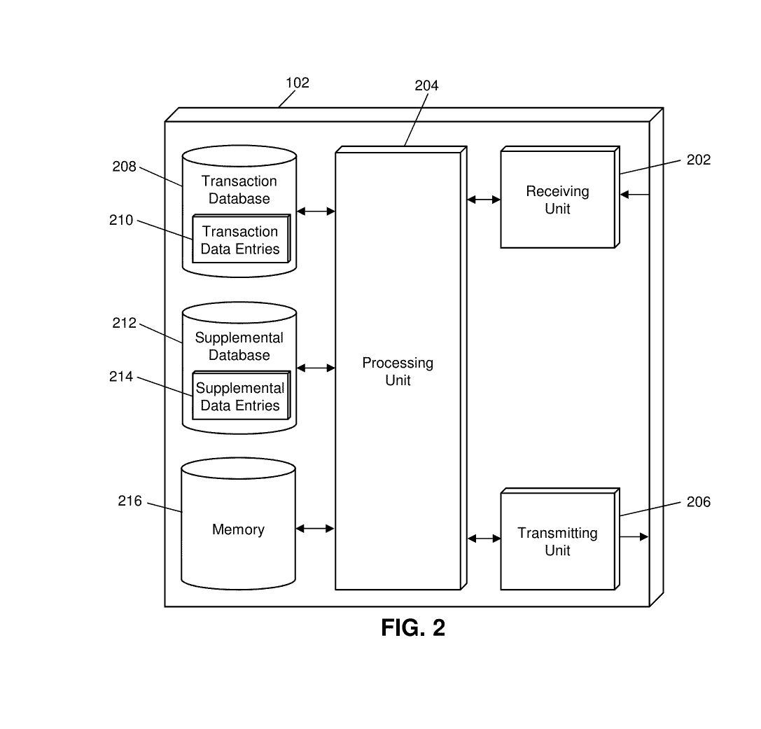

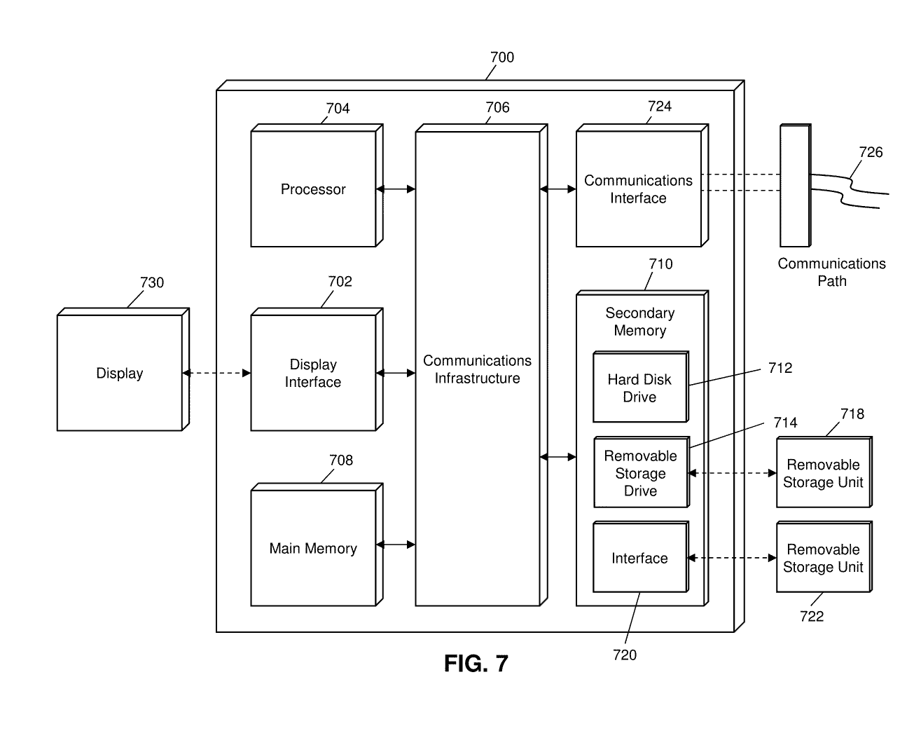

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 700 illustrated in FIG. 7 and discussed in more detail below may be a suitable configuration of the processing server 102.

The processing server 102 may include a receiving unit 202. The receiving unit 202 may be configured to receive data over one or more networks via one or more network protocols. The receiving unit 202 may receive one or more time series variables from the requesting entity 104 for which a relationship is to be identified. The received time series variables may include a time period, time interval, and a data value for each time interval in the time period for each time series variable. In some instances, when multiple time series variables are received, they each may have a common time period and time interval.

The receiving unit 202 may also be configured to receive data associated with a plurality of payment transactions, such as from the payment network 106. The data may be stored in a transaction database 208 in a plurality of transaction data entries 210. Each transaction data entry 210 in the transaction database 208 may include data related to a payment transaction including at least a transaction time and/or date and other transaction data. The other transaction data may include a transaction amount, geographic location, merchant data (e.g., merchant name, merchant industry, merchant category, etc.), product data, consumer data, payment data, and any other suitable data.

In some embodiments, the receiving unit 202 may also be configured to receive additional, supplemental data from one or more third party data sources 108. The supplemental data may be stored in a supplemental database 212 in a plurality of supplemental data entries 214. Each supplemental data entry 214 may be configured to store data related to one or more various metrics and include at least a plurality of data points and an associated time and/or date for each data point. For instance, if a supplemental data entry 214 stores weather data, it may include a temperature for each day over a period of time for use in identifying temperature time series variables.

The processing server 102 may also include a processing unit 204. The processing unit 204 may be configured to perform the functions of the processing server 102 discussed herein as will be apparent to persons having skill in the relevant art. The processing unit 204 may be configured to identifying a plurality of time series variables based on the transaction data entries 210 stored in the transaction database 208. Each identified time series variable may be for a time period and with time intervals corresponding to time series variables received by the receiving unit 202. The data values for each of the identified time series variables may be based on the transaction data included in transaction data entries 210 with transaction times and/or dates corresponding to the time interval of the corresponding data value. In embodiments where the processing unit 102 includes the supplemental database 212, the processing unit 204 may also be configured to identify time series variables for each of the metrics related to the supplemental data entries 214 based on the data stored therein.

The processing unit 204 may be further configured to identify a relationship between each received time series variable and one or more identified time series variable. The relationship may be identified based on a correspondence between the data values for the received time series variable and the data values for each of the corresponding related time series variables. In some instances, the correspondence may be between data values of the same time intervals. In other instances, the correspondence may be between data values of lagging or leading time intervals.

In some embodiments, the processing unit 204 may also be configured to forecast future performance for the received time series variables. The forecasted future performance may be based on the data values for one or more of the related time series variables that were previously identified by the processing unit 204. In some instances where a received time series variable may be related to multiple time series variables, the forecasted future performance may be based on the data values for each of the related time series variables. The future performance may also be forecast based on additional rules and/or algorithms used for forecasting future performance, and any other suitable data as will be apparent to persons having skill in the relevant art.

The processing server 102 may include a transmitting unit 206. The transmitting unit 206 may be configured to transmit data over one or more networks. The transmitting unit 206 may transmit data to the requesting entity 104 in response to the originally received time series variables. In some embodiments, the transmitting unit 206 may transmit relationship data, such as an identified relationship, the data values for the related time series variable(s), etc. In other embodiments, the transmitting unit 206 may transmit forecasted future performance to the requesting entity 104. In such an embodiment, the transmission may include forecasted future data values identified by the processing unit 204. In some instances, the data transmitted by the transmitting unit 206 may be specified in a request initially received by the receiving unit 202 from the requesting entity 104, such as accompanying the received time series variables and specifying the data. For example, the requesting entity 104 may specify a data forecast for a specific period of time.

The processing server 102 may further include a memory 216. The memory 216 may be configured to store data suitable for performing the functions of the processing server 102 discussed herein. For example, the memory 216 may be configured to store rules or algorithms for use in identifying time series variables, for identifying relationships between time series variables, for forecasting future performance based on variable relationships, etc. Additional data that may be stored in the memory 216 will be apparent to persons having skill in the relevant art.

It may be further apparent to persons having skill in the relevant art that the processing server 102 may include additional components, and/or that the components included in the processing server 102 as illustrated in FIG. 2 and discussed herein may be configured to perform additional functions. For example, in embodiments where the processing server 102 may be a part of the payment network 106, the components of the processing server 102 may be further configured to perform functions of the payment network 106, such as for the processing of payment transactions.

### Process for Identifying Time Series Variable Relationships

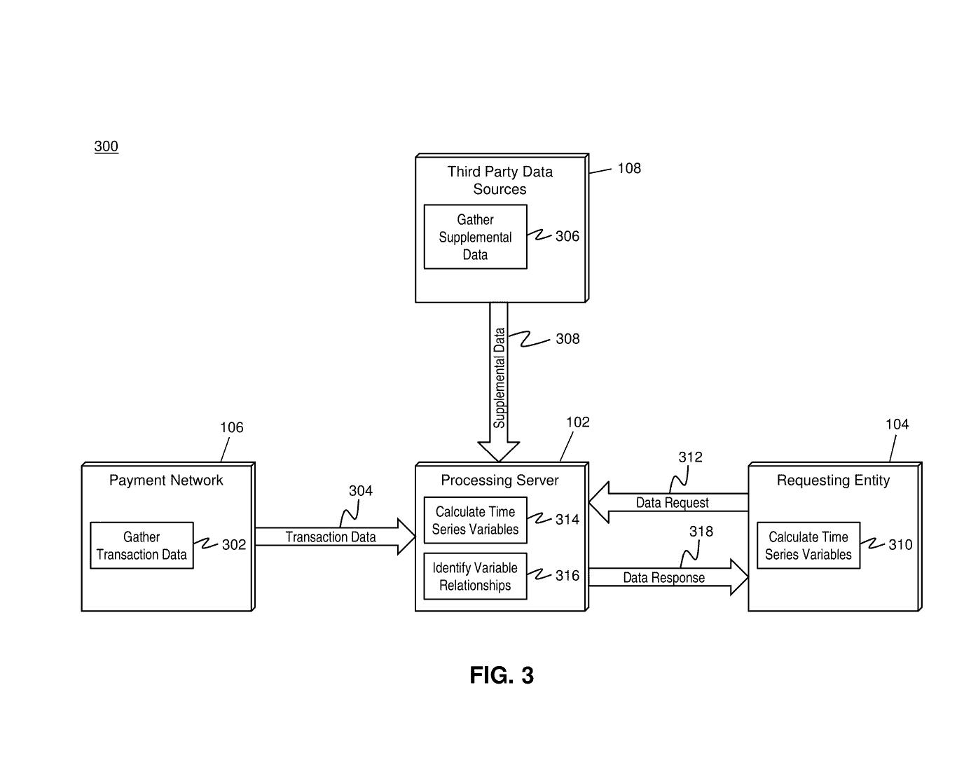

FIG. 3 illustrates a process 300 for the identification of relationships between time series variables using the system 100.

In step 302, the payment network 106 may gather data for a plurality of payment transactions. The data may be gathered during processing of the payment transactions or via any type of suitable method or system as will be apparent to persons having skill in the relevant art. In step 304, the payment network 106 may transmit the transaction data to the processing server 102, to be received by the receiving unit 202. The transaction data may be stored in the transaction database 208 as the plurality of transaction data entries 210.

In step 306, one or more third party data sources 108 may gather supplemental data. In step 308, the supplemental data may be transmitted to the processing server 102, to be received by the receiving unit 202 and stored in the supplemental database 212 as the plurality of supplemental data entries 214.

In step 310, the requesting entity 104 may be configured to calculate one or more requestor time series variables. Each requestor time series variable may be a variable for which the requesting entity 104 desires a relationship or data forecast, and may include a time period, time interval, and a data value for each time interval in the time period. In step 312, the requesting entity 104 may transmit a data request to the processing server 102, to be received by the receiving unit 202. The data request may include each of the calculated requestor time series variables and may further include data indicating what information is being requested. For example, the data request may indicate a request for relationships, may indicate a request for a data forecast for the next three time intervals, etc.

In step 314, the processing unit 204 of the processing server 102 may calculate a plurality of processor time series variables. Each processor time series variable may be calculated using the same time period and time interval as the requestor time series variables and may be based on the transaction data included in each of the transaction data entries 210 and/or the supplemental data included in the supplemental data entries 214. In step 316, the processing unit 204 may identify relationships between the calculated processor time series variables and each of the requestor time series variables based on the data values for each time interval included therein. In instances where the received data request indicates a request for forecasted data, step 316 may also include forecasting future performance for the requestor time series variables as requested based on the data values for the related processor time series variables.

In step 318, the transmitting unit 206 may transmit a data response to the requesting entity 104. The data response may include the data requested by the requesting entity 104 in the earlier data request, such as the relationship data, data values for the related processor time series variables, the forecasted future performance, etc.

### Time Series Variable Relationships

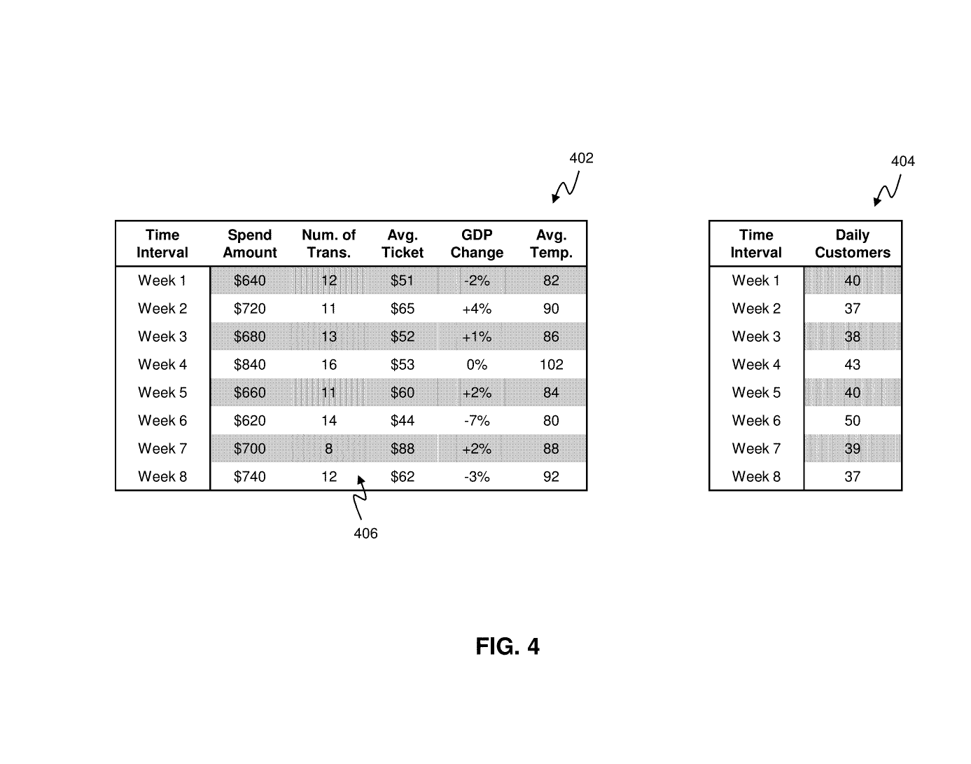

FIG. 4 illustrates processor and requestor time series variables for use in identification of a relationship thereof.

The table 402 includes a plurality of processor time series variables. Each time series variable may be calculated based on transaction data in the transaction data entries 210 of the transaction database 208 of the processing server 102 or the data points in the supplemental data entries 214 of the supplemental database 212. For instance, in the example illustrated in FIG. 4, the table 402 includes three time series variables calculated from transaction data, average spend amount, average number of transactions, and average ticket size, and two time series variables calculated from supplemental data, GDP change and average temperature.

Each processor time series variable includes a data value 406 for each time interval over a time period. In the example illustrated in FIG. 4, there is a data value 406 for each time interval of one week over an eight-week time period. Table 404 includes a requestor time series variable received by the receiving unit 202 from the requesting entity 104. The requestor time series variable includes a data value 406 for each of the time intervals during the time period that corresponds to the same time intervals and time period for the processor time series variables included in the table 402.

The processing unit 204 of the processing server 102 may be configured to identify a relationship between one or more processor time series variables in the table 402 and the requestor time series variable in the table 404. In the example illustrated in FIG. 4, the processing unit 204 may identify a relationship between the average spend amount and average temperature with the daily customers provided by the requesting entity 104. In the illustrated example, the average spend amount and average temperature have values that are directly proportional to the daily customers with a two month lead. That is to say, the average spend amount and average temperature for a given week are directly proportional to the number of daily customers two weeks later.

### Forecasting Future Performance

FIG. 5 illustrates the forecasting of future performance based on identified relationships between time series variables.

Chart 502 is a line graph illustrating the average spend amount processor time series variable included in table 402 illustrated in FIG. 4 and discussed above. The chart 502 includes a line 504 that illustrates the changes in the average spend amount from one time interval to the next based on the data values of the time series variable.

Chart 506 is a line graph illustrating the average number of daily customers requestor time series variable included in table 404 illustrated in FIG. 4 and discussed above. The chart 506 includes a line 508 that illustrates the changes in the average number of daily customers from one time interval to the next based on the data values of the time series variable.

As discussed above, the processing unit 204 of the processing server 102 may identify a relationship between the average spend amount and average daily customer time series variables. The average spend amount is identified to be related to the average daily customers and to lead the average daily customers by two weeks. This is illustrated in FIG. 5 where the line 504 directly corresponds to the line 508, but with week values for the line 504 that are two weeks ahead of the week values of the line 508.

The processing unit 204 may be able to forecast the future performance of the average daily customers time series variable based on its relationship with the average spend amount and the known data values for the average spend amount time series variable. As illustrated in FIGS. 4 and 5, the data values for the average daily customers are directly proportional to the data values for the average spend amount on a two week lag. As the data values for weeks 7 and 8 for the average spend amount, which correspond to weeks 9 and 10 of the average daily customers, which have not yet occurred, the number of average daily customers for weeks 9 and 10 can be forecasted by the processing unit 204 accordingly. In the illustrated example, the processing unit 204 may identify a forecast 510 for the average daily customers during future weeks 9 and 10 that matches the line 504 for weeks 7 and 8 of the average spend amount.

### Exemplary Method for Identifying Relationships Between Time Series Variables

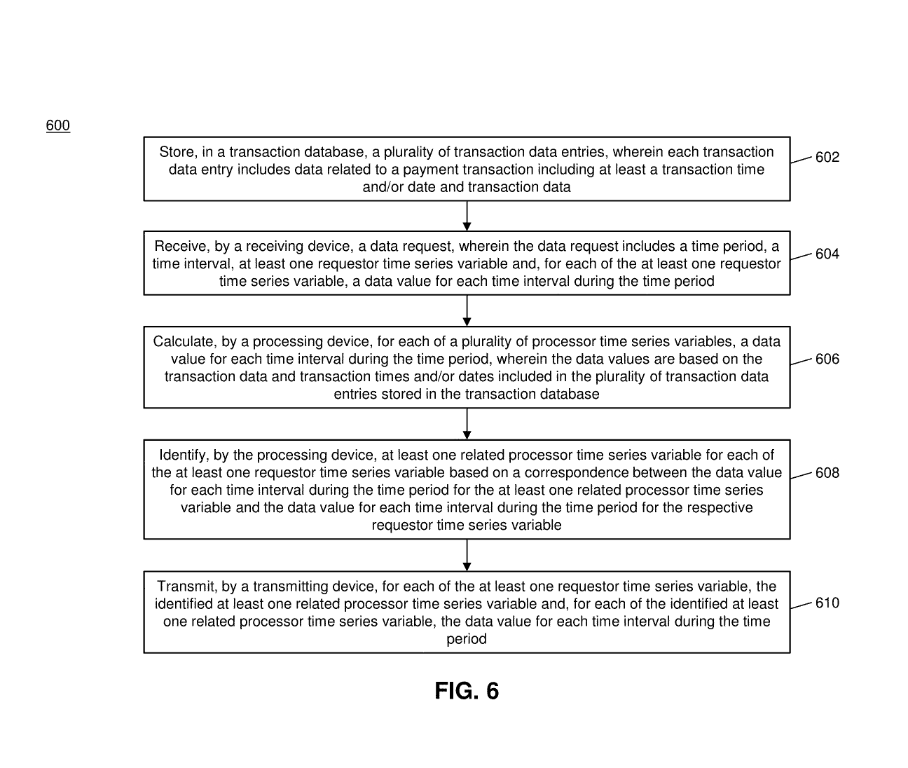

FIG. 6 illustrates a method 600 for identifying relationships between supplied time series variables and time series variables calculated based on consumer spending data.

In step 602, a plurality of transaction data entries (e.g., transaction data entries 210) may be stored in a transaction database (e.g., the transaction database 208), wherein each transaction data entry 210 includes data related to a payment transaction including at least a transaction time and/or date and transaction data. In one embodiment, the transaction data may include at least one of: transaction amount, geographic location, merchant data, product data, consumer data, and payment data. In step 604, a data request may be received by a receiving device (e.g., the receiving unit 202), wherein the data request includes a time period, a time interval, at least one requestor time series variable, and, for each of the at least one requestor time series variable, a data value for each time interval during the time period.

In step 606, a data value may be calculated by a processing device (e.g., the processing unit 204) for each of a plurality of processor time series variables for each time interval during the time period, wherein the data values are based on the transaction data and transaction times and/or dates included in the plurality of transaction data entries 210 stored in the transaction database 208. In some embodiments, the plurality of processor time series variables may include at least one of: number of transactions, frequency of transactions, total spend amount, average spend amount, and average ticket size for a consumer, account, merchant, or product during the time period.

In step 608, at least one related processor time series variable may be identified, by the processing device 204, for each of the at least one requestor time series variables based on a correspondence between the data value for each time interval during the time period for the at least one related processor time series variable and the data value for each time interval during the time period for the respective requestor time series variable. In one embodiment, the correspondence is a correspondence between the data values at first time intervals during the time period for the at least one related processor time series variable and the data values at second time intervals during the time period for the respective requestor time series variable. In a further embodiment, the second time intervals may be a predetermined period of time after the first time intervals. In another further embodiment, the second time intervals may be a predetermined period of time before the first time intervals.

In step 610, a transmitting device (e.g., the transmitting unit 206) may transmit, for each of the at least one requestor time series variable, the identified at least one related processor time series variable and, for each of the identified at least one related processor time series variable, the data value for each time interval during the time period. In some embodiments, the identified at least one processor time series variable and associated data values for each time interval during the time period are transmitted in response to the received data request. In one embodiment, the method 600 may also include: storing, in a supplemental database (e.g., the supplemental database 212), a plurality of supplemental data entries (e.g., supplemental data entries 214), wherein each supplemental data entry 214 includes data related to one or more metrics including a plurality of data points and, for each of the plurality of data points, an associated time and/or date; calculating, by the processing device 204, for each supplemental data entry 214, a supplemental time series variable and a corresponding data value for each time interval during the time period, wherein the data values are based on the plurality of data points and associated time and/or date included in the respective supplemental data entry 214; and including, in the plurality of processor time series variables, each of the calculated supplemental time series variables.

In some embodiments, the transmission is made to the processing device 204, and the method 600 further comprises: forecasting, by the processing device 204, future performance for each of the at least one requestor time series variables at one or more future time intervals based on the data values for the respective at least one related processor time series variables. In a further embodiment, the method 600 may even further include transmitting, by the transmitting device 206, the forecasted future performance for each of the at least one requestor time series variables in response to the received data request.

### Computer System Architecture

FIG. 7 illustrates a computer system 700 in which embodiments of the present disclosure, or portions thereof, may be implemented as computer-readable code. For example, the processing server 102 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3 and 6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

Techniques consistent with the present disclosure provide, among other features, systems and methods for identifying relationships between time series variables. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for identifying relationships between time series variables, comprising:
storing, in a transaction database, a plurality of transaction data entries, wherein each transaction data entry includes data related to a payment transaction including at least a transaction time and/or date and transaction data;
receiving, by a receiving device, a data request, wherein the data request includes a time period, a time interval, at least one requestor time series variable and, for each of the at least one requestor time series variable, a data value for each time interval during the time period;
calculating, by a processing device, for each of a plurality of processor time series variables, a data value for each time interval during the time period, wherein the data values are based on the transaction data and transaction times and/or dates included in the plurality of transaction data entries stored in the transaction database;
identifying, by the processing device, at least one related processor time series variable for each of the at least one requestor time series variable based on a correspondence between the data value for each time interval during the time period for the at least one related processor time series variable and the data value for each time interval during the time period for the respective requestor time series variable; and
transmitting, by a transmitting device, for each of the at least one requestor time series variable, the identified at least one related processor time series variable and, for each of the identified at least one related processor time series variable, the data value for each time interval during the time period.

2. The method of claim 1, wherein the identified at least one processor time series variable and associated data values for each time interval during the time period are transmitted to the processing device, and the method further comprises:
forecasting, by the processing device, future performance of each of the at least one requestor time series variable at one or more future time intervals based on the data values for the respective at least one related processor time series variable.

3. The method of claim 2, further comprising:
transmitting, by the transmitting device, the forecasted future performance for each of the at least one requestor time series variable in response to the received data request.

4. The method of claim 1, wherein the identified at least one processor time series variable and associated data values for each time interval during the time period are transmitted in response to the received data request.

5. The method of claim 1, wherein the correspondence between the data value for each time interval during the time period for the at least one related processor time series variable and the data value for each time interval during the time period for the respective requestor time series variable is a correspondence between the data values at first time intervals during the time period for the at least one related processor time series variable and the data values at second time intervals during the time period for the respective requestor time series variable.

6. The method of claim 5, wherein the second time intervals are a predetermined period of time after the first time intervals.

7. The method of claim 5, wherein the second time intervals are a predetermined period of time before the first time intervals.

8. The method of claim 1, wherein the transaction data includes at least one of: transaction amount, geographic location, merchant data, product data, consumer data, and payment data.

9. The method of claim 8, wherein the plurality of processor time series variables includes at least one of: number of transactions, frequency of transactions, total spend amount, average spend amount, and average ticket size for a consumer, account, merchant, or product during the time period.

10. The method of claim 1, further comprising:
storing, in a supplemental database, a plurality of supplemental data entries, wherein each supplemental data entry includes data related to one or more metrics including a plurality of data points and, for each of the plurality of data points, an associated time and/or date;
calculating, by the processing device, for each supplemental data entry, a supplemental time series variable and a corresponding data value for each time interval during the time period, wherein the data values are based on the plurality of data points and associated time and/or date included in the respective supplemental data entry; and
including, in the plurality of processor time series variables, each of the calculated supplemental time series variables.

11. A system for identifying relationships between time series variables, comprising:
a transaction database configured to store a plurality of transaction data entries, wherein each transaction data entry includes data related to a payment transaction including at least a transaction time and/or date and transaction data;
a receiving device configured to receive a data request, wherein the data request includes a time period, a time interval, at least one requestor time series variable and, for each of the at least one requestor time series variable, a data value for each time interval during the time period;
a processing device configured to
calculate, for each of a plurality of processor time series variables, a data value for each time interval during the time period, wherein the data values are based on the transaction data and transaction times and/or dates included in the plurality of transaction data entries stored in the transaction database, and
identify at least one related processor time series variable for each of the at least one requestor time series variable based on a correspondence between the data value for each time interval during the time period for the at least one related processor time series variable and the data value for each time interval during the time period for the respective requestor time series variable; and
a transmitting device configured to transmit, for each of the at least one requestor time series variable, the identified at least one related processor time series variable and, for each of the identified at least one related processor time series variable, the data value for each time interval during the time period.

12. The system of claim 11, wherein
the identified at least one processor time series variable and associated data values for each time interval during the time period are transmitted to the processing device, and
the processing device is further configured to forecast future performance of each of the at least one requestor time series variable at one or more future time intervals based on the data values for the respective at least one related processor time series variable.

13. The system of claim 12, wherein the transmitting device is further configured to transmit the forecasted future performance for each of the at least one requestor time series variable in response to the received data request.

14. The system of claim 11, wherein the identified at least one processor time series variable and associated data values for each time interval during the time period are transmitted in response to the received data request.

15. The system of claim 11, wherein the correspondence between the data value for each time interval during the time period for the at least one related processor time series variable and the data value for each time interval during the time period for the respective requestor time series variable is a correspondence between the data values at first time intervals during the time period for the at least one related processor time series variable and the data values at second time intervals during the time period for the respective requestor time series variable.

16. The system of claim 15, wherein the second time intervals are a predetermined period of time after the first time intervals.

17. The system of claim 15, wherein the second time intervals are a predetermined period of time before the first time intervals.

18. The system of claim 11, wherein the transaction data includes at least one of: transaction amount, geographic location, merchant data, product data, consumer data, and payment data.

19. The system of claim 18, wherein the plurality of processor time series variables includes at least one of: number of transactions, frequency of transactions, total spend amount, average spend amount, and average ticket size for a consumer, account, merchant, or product during the time period.

20. The system of claim 11, further comprising:
a supplemental database configured to store a plurality of supplemental data entries, wherein each supplemental data entry includes data related to one or more metrics including a plurality of data points and, for each of the plurality of data points, an associated time and/or date, wherein
the processing device is further configured to
calculate, for each supplemental data entry, a supplemental time series variable and a corresponding data value for each time interval during the time period, wherein the data values are based on the plurality of data points and associated time and/or date included in the respective supplemental data entry, and
include, in the plurality of processor time series variables, each of the calculated supplemental time series variables.
